(19) United States
(12) Patent Application Publication
(10) Pub. No.: US 2022/0090725 A1
(43) Pub. Date: Mar. 24, 2022

(54) CENTRALIZERS FOR INSPECTION OF LINED PIPELINES

(71) Applicant: Russell NDE Systems Inc., Edmonton (CA)

(72) Inventors: David Russell, Edmonton (CA); Daniel Lingnau, Edmonton (CA); Ellen Jin, Edmonton (CA); Ad Shatat, Edmonton (CA)

(73) Assignee: Russell NDE Systems Inc., Edmonton (CA)

(21) Appl. No.: 17/031,639

(22) Filed: Sep. 24, 2020

(51) Int. Cl. F16L 55/40

(52) U.S. Cl. CPC F16L 55/40; F16L 2101/30

(57) ABSTRACT

A centralizer for centrally locating measuring/testing equipment within the interior of a pipeline while traveling through the pipeline includes a first flange structure and a second flange structure nominally spaced from the first flange structure along the direction of travel of the centralizer. A plurality of radially outwardly curved loops extending between the first and second flange structures to form curved arches that define an outwardly convex outer surface. One or more ridges, or a single or a plurality of wheels, extending along the loops to project outwardly of the outer surfaces of the arches to extend above the remainder of the outer surface of the arches to bear against the interior of the pipeline.

### BACKGROUND

Pipelines have been used for many years for carrying flowable content, including many types of fluids and fluid mixtures. The pipelines may be buried in the ground or supported above ground. In-Line Inspection (ILI) tools have been used for inspecting pipelines for corrosion, cracks, failed seams, and other damage. The ILI tools typically include sensors that are placed in relatively close contact with the pipe to maximize sensor sensitivity. Sensing technology may be based on electromagnetic, acoustic, thermal, or visual measurements. Centralizers typically have been utilized in conjunction with the ILI tools to support the sensors close to but not in actual contact with the interior of the pipeline. Such centralizers typically have consisted of wire brush bristles, urethane pig cups or disks.

Commonly, to increase the service life of pipelines, internal liners have been placed within pipelines or coatings applied to the interior of the pipeline. Such lining and coating materials may include cement mortar, polyurethane, high-density polyurethane, epoxy and other materials. Such liners and coatings resist corrosion and thus provide protection to the pipeline. Nonetheless, pipelines may still corrode from the exterior or from the interior due to cracks or other damage to the pipeline. Thus, even after lining or coating, pipelines still need to be inspected to assess the condition of the pipeline.

It is important that the ILI tool used for inspection not damage the liner of the pipeline, for instance, by the instrument housings scraping against the liner or the centralizers, which must be in contact with the liner, themselves causing damage to the liner. Thus, the centralizers must be capable of compensating for variations in the diameter of the lined pipeline while still being stiff enough to support the weight of the ILI tools away from the liner surface and not damage the liner surface. The present disclosure pertains to centralizers for ILI tools that seek to address the foregoing requirements.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a centralizer is provided for centrally locating measuring/testing equipment within the interior of a pipeline while traveling through the pipeline. The centralizer includes a first flange structure, a second flange structure nominally spaced from the first flange structure along the direction of travel of the centralizer, a plurality of radially outwardly curved loops extending between the first and second flange structures, said curved loops defining an outwardly convex outer surface, and one or more ridges extending along the loops to project outwardly of the outer surfaces of the loops to extend above the remainder of the outer surface of the loops.

In any of the embodiments described herein, wherein the loops have side edge portions, and wherein ridges extend along the side edge portions of the loops.

In any of the embodiments described herein, wherein the loops, when in an undeformed state, comprise flat straps that extend radially and substantially coplanar to each other from a first flange structure to terminate at distal end portions.

In any of the embodiments described herein, wherein the outwardly concave form of the loops is created by flexing each of the nominally linear straps over on itself so that the distal end portions of the straps meet together at a location spaced apart from the first flange structure in a direction along the direction of travel of the centralizer.

In any of the embodiments described herein, wherein the radial end portions of the straps are configured to define at least a portion of the second flange structure when the nominally straight straps are flexed over on themselves to form loops.

In any of the embodiments described herein, wherein the loops provide a resistance load against the movement of the first and second flange structures toward each other.

In any of the embodiments described herein, wherein the resistance load against the first and second flanges of a centralizer moving relatively toward each other is in the range of about 3 to 20 pounds' force.

A centralizer assembly comprised of two or more centralizers constructed in accordance with any of the embodiments described herein, wherein the one flange structure of a first centralizer is disposed face-to-face with the adjacent flange of the second centralizer.

An apparatus for measuring/testing the condition of a pipeline wherein an articulating joint is disposed within the centralizer of any of the embodiments described herein, between the first and second flange structures of the centralizer.

In any of the embodiments described herein, wherein the articulating joint interconnects adjacent components of measuring/testing equipment.

In accordance with another embodiment of the present disclosure, a centralizer is provided for centrally locating measuring/testing equipment within the interior of a pipeline while traveling through the pipeline. The centralizer includes a first annular face structure, a second annular face structure nominally spaced from the first face structure along the direction of movement of the centralizer, the first and second face structures nominally aligned with each other along a first axis coinciding with the direction of travel of the centralizer through the pipeline, a plurality of radially outwardly curved loops extending between the first and second face structures, one or more wheels mounted on the loops to define the maximum outer perimeter of the centralizer, said one or more wheels mounted on a rotational axis extending nominally transversely to the first axis, the one or more wheels adapted to roll against the interior of the pipeline structure being inspected/tested.

In any of the embodiments described herein, wherein the loops are formed with openings for closely receiving the wheels therein.

In any of the embodiments described herein, wherein the loops define a thickness, with the thickness of the loops at the location that the wheels are mounted on the loops being increased in thickness to define mounting bosses for axles on which the wheels are journaled.

In any of the embodiments described herein, wherein the loops are formed with distal end lugs adjacent the juncture of the loops with the first and second face structures.

In any of the embodiments described herein, further comprising a slit extending through the end lugs to the exterior of the loops to facilitate the flexing of loops upon a force applied to the wheel mounted on the loop.

In any of the embodiments described herein, wherein the loops define a convex outer surface, and further comprising one or more flexible reinforcing strips extending along the outer surfaces of the loops, the reinforcing strips loading the loop to bias the loop to maintain its nominally curved shape.

In any of the embodiments described herein, wherein the reinforcing strips are nominally straight and are attached to an outer surface of the loops along lengths of the reinforcing strips.

In any of the embodiments described herein, wherein the loops defining side surfaces generally transverse to the outer surface of the loops, and further comprising one or more nominally straight reinforcing strips overlapping the side surfaces of the loops.

In any of the embodiments described herein, wherein the loops define a convex outer surface, and further comprising one or more flexible reinforcing strips extending along the outer surface of the loops, the reinforcing strips mounted to the loops to bias the loops to their nominally curved shape.

In any of the embodiments described herein, wherein the reinforcing strips are nominally straight and are attached to the outer surface of the loops along a significant length of the reinforcing strips.

In any of the embodiments described herein, wherein the loops have side surfaces generally transverse to the outer surface of the loops, and further comprising one or more nominally straight reinforcing strips overlapping the side surfaces of the loops.

In any of the embodiments described herein, wherein the loops have side surfaces, and further comprising reinforcing strips overlapping the side surfaces of the loops, said side surfaces applying a load to the loops to bias the loops to maintain their nominally curved shape.

In any of the embodiments described herein, further comprising two wheels mounted on the loops, the outer circumference of the two wheels defining the outer perimeter of the centralizer, the two wheels mounted on the loops about rotational axles extending generally transversely to the first axis.

In any of the embodiments described herein, further comprising an articulating joint disposed within the interior of the centralizer and spanning between the first and second face structures.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial view of a first embodiment of the present disclosure illustrating a section of an ILI tool;

FIG. 2 is an exploded view of a portion of FIG. 1;

FIG. 3 is an end view of the tool section shown in FIG. 1 taken along lines 3-3 thereof;

FIG. 4 is a cross-sectional view of FIG. 1 taken along lines 4-4 thereof;

FIG. 5 is an elevational view of the ILI tool segment of FIGS. 1-4 shown disposed within a pipeline;

FIG. 6 is a view of the centralizer shown in FIGS. 1-5, prior to being assembled;

FIG. 7 is an isometric view of a second embodiment of the present disclosure;

FIG. 8 is an enlarged view of a portion of the ILI tool segment of FIG. 7 with portions sectioned away so that the interior of the centralizer is visible;

FIG. 9 is an isometric view of the centralizer shown in FIGS. 7 and 8;

FIG. 10 is an end view of FIG. 9;

FIG. 11 is a cross-sectional view of FIG. 10 taken along lines 11-11 thereof;

FIG. 12 is a partial exploded view of the centralizer of FIGS. 7-11;

FIG. 13 is an elevation view of a further embodiment of the present disclosure showing an ILI tool segment within a pipeline;

FIG. 14 is an isometric view of a centralizer as shown in FIG. 13;

FIG. 15 is an end view of the centralizer of FIGS. 13 and 14;

FIG. 16 is a cross-sectional view of FIG. 15 taken along lines 16-16 thereof;

FIG. 17 is an isometric view of a further embodiment of the present disclosure;

FIG. 18 is an exploded view of FIG. 17;

FIG. 19 is a partial cross-sectional view of FIG. 17;

FIG. 20 is an enlarged view of a portion of the centralizer shown in FIGS. 17-19; and

FIG. 21 is a cross-sectional view of FIG. 20 taken along lines 21-21 thereof.

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “top,” “bottom,” “right hand,” “left hand,” “in,” “out,” “extended,” “advanced,” “retracted,” “proximal,” and “distal.” These references and other similar references in the present application are only to assist in helping describe and understand the present invention and are not intended to limit the present invention to these directions or designations.

The present application may include modifiers such as the words “generally,” “approximately,” “about”, or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

In the following description, various embodiments of the present disclosure are described. In the following description and in the accompanying drawings, the corresponding systems assemblies, apparatus and units may be identified by the same part number, but with an alpha suffix. The descriptions of the parts/components of such systems assemblies, apparatus, and units that are the same or similar are not repeated so as to avoid redundancy in the present application.

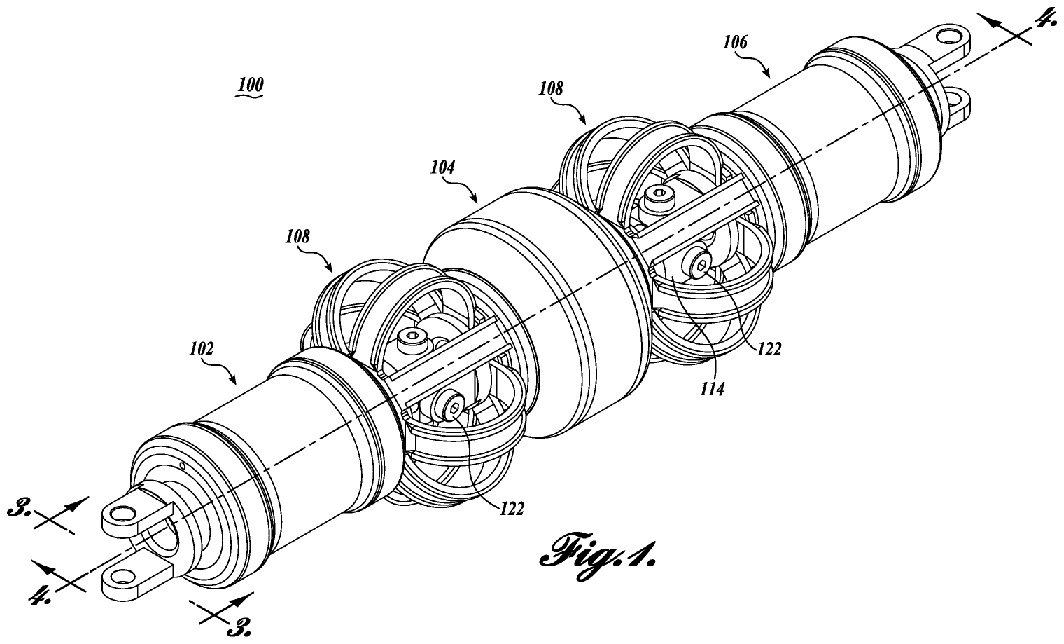

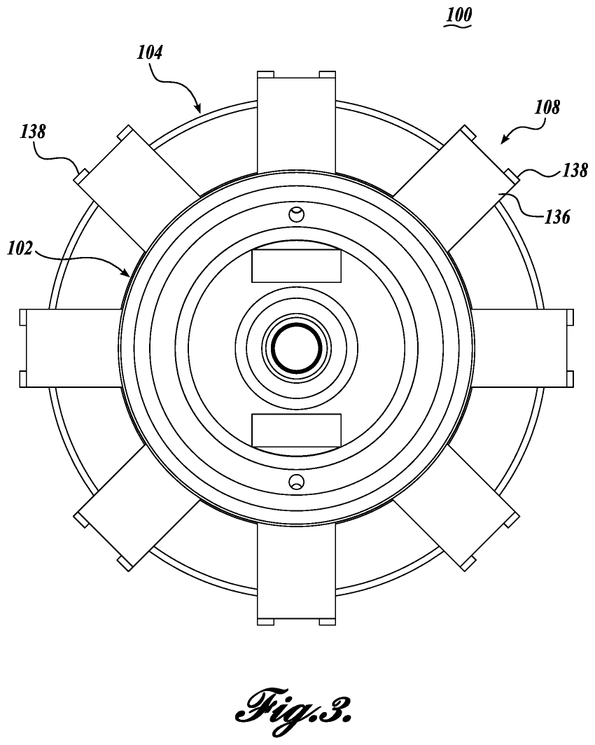

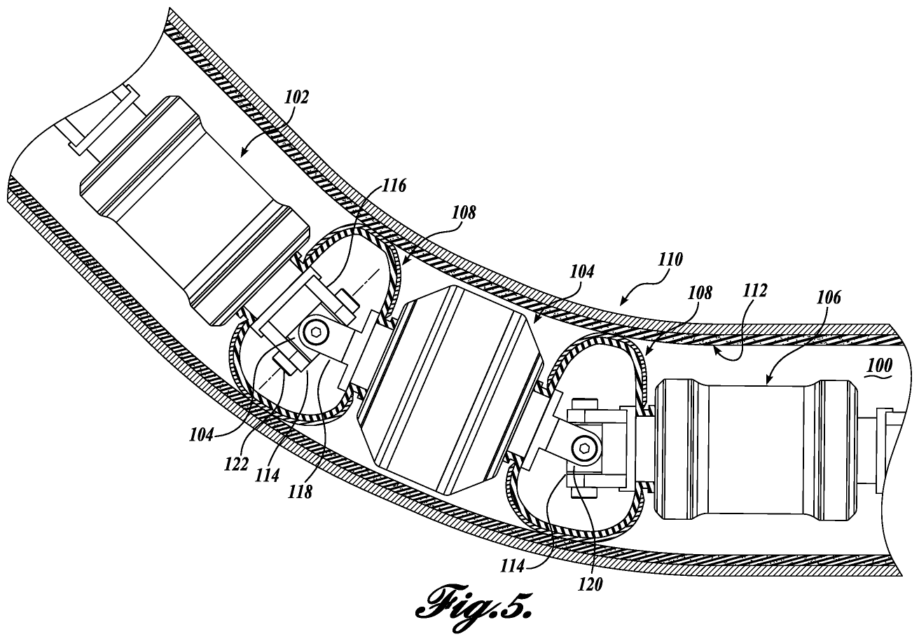

Referring initially to FIGS. 1-6, a portion of an ILI tool 100 is illustrated, including first, second, and third modules 102, 104, and 106, separated by centralizers 108 which function to support and center the ILI tool 100 within a pipeline 110, see FIG. 5. The modules 102, 104, and 106 may house various components of the ILI tool, for example, electromagnetic, acoustical, thermal, or visual sensors, as well as electromagnetic or acoustic signal generators. The modules may also house data processing equipment, power supplies, transceivers, and other components of an ILI tool. These components can cause the modules 102, 104, and 106 to be of significant weight, which could cause damage to the liner 112 disposed along the interior of the pipeline 110 if the modules were to slide against the liner.

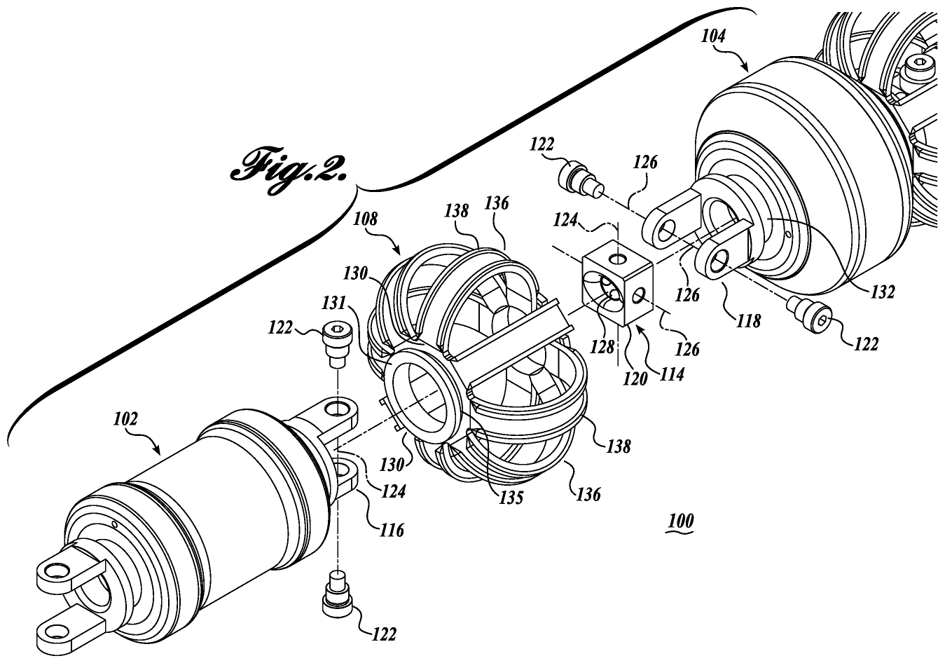

As shown in the FIGS. 1, 2, 4, and 5, the modules 102, 104, and 106 are interconnected by universal joints 114, composed of yokes 116 and 118 projecting from modules 102 and 104, as shown in FIG. 2. A cross 120 formed in a generally cubic shape is sized to be received between the arms of the yokes 116 and 118. Bearing pins 122 extend through aligned holes formed in the yokes 116 and 118 to engage within corresponding cross holes formed in the cross 120 to attach the yokes to the cross while allowing relative rotation between the yokes and cross about axes 124 and 126 extending through the center of the yokes 116 and 118. A longitudinal center 128 of the cross 120 is hollow to enable cables, wires, etc., to pass therethrough between the modules 102 and 104.

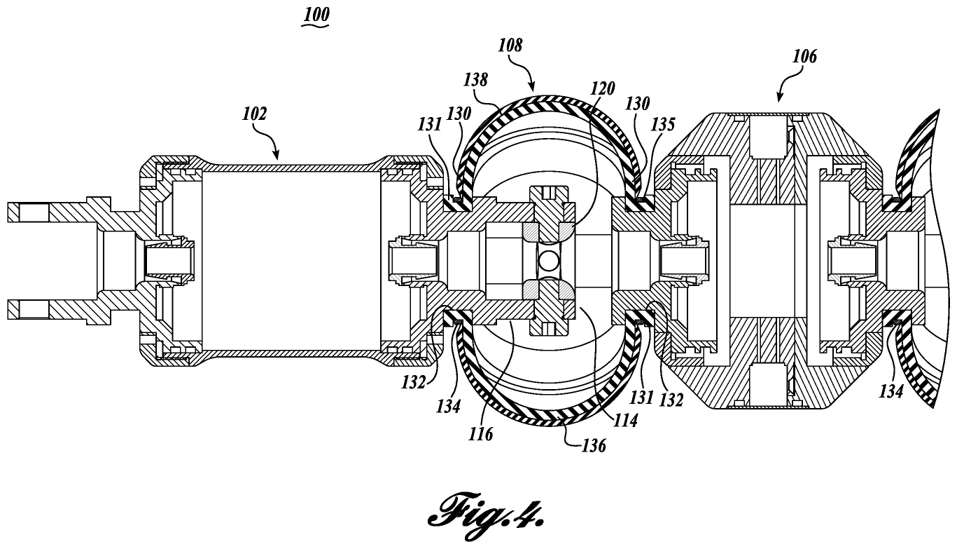

Next, with respect to the construction of the centralizer 108, the centralizer includes flange 130 on each side of the centralizer that defines the faces of the centralizer. The flanges 130 define a hub portion 131 that is sized and shaped to be receivable within grooves 132 formed in the yokes 116 and 118 inward of the yoke arms and exterior to the modules 102, 104, and 106, see in particular FIG. 4. In this manner, the centralizers 108 are held captive within the grooves 132. A retaining ring 134 can be inserted into an exterior groove 135 defined by the hub 131 to secure the hub in engagement with the yokes. Of course, other means can be used to secure the centralizers 108 in place relative to the modules 102, 104, and 106. For example, mechanical fasteners can be used to secure hubs 131 to yokes 116 and 118.

A plurality of arches or loops 136 extend between the two flange structures 130 of the centralizer. The arches/loops define a convex outer surface for bearing against the inside of the liner 112. Ridges or ribs 138 extend along the side margins of the arches/loops 136 to define the outward-most surface or portion of the arches/loops. As such, only the surface ridges 138 actually bear against the pipeline liner 112, thereby reducing the contact area between the centralizers and the liner 112. This reduces the friction load between the centralizers and the liner.

Although two ribs are illustrated for each arch 136, extending along the margins of the arches, a different number of ridges can be utilized. For example, a third ridge, not shown, could extend along the length of the arches centrally between the marginal ridges 138.

The arches 136 are designed to be flexible, such as when the centralizers are rounding a corner, as shown in FIG. 5. In this regard, the arches to the inside of the corner are compressed, whereas the arches to the outside of the corner are elongated, thereby maintaining the modules 102, 104, and 106 centrally within the pipeline. To achieve such compression or extension while still providing sufficient strength to maintain the module centered within the pipeline, the arches can be constructed from satisfactory materials, for example, polyurethane or other plastics or natural or synthetic rubber. As one example, for a 4-inch diameter pipe, the arches can be from 1 to 1.5 inch wide and from ⅛ to ¼ inch thick. Moreover, the ridges 138 can extend from ⅛ to ¼ inches above the surface of the arch and have a width of from about ⅛ to ¼ inches. Of course, the centralizer can be constructed in other dimensions, depending on various factors, such as the overall size of the centralizer and the mass/weights of the modules. Nonetheless, it will be appreciated that by constructing the centralizers 118 as described above, the modules 102, 104, 106 are supported centrally within the pipeline 110, even when negotiating the corner, while avoiding damaging the liner 112 during travel of the ILI tool through the pipeline.

Once the ILI tool 100 has traveled past the bend or corner shown in FIG. 5, the centralizer arches 136, which were located at the inside of the corner, are capable of flexing outwardly to resume their nominal shapes as shown in FIGS. 2 and 4. Correspondingly, arches 108 located on the outside of the corner contract inwardly to resume their nominal shape as shown in FIGS. 2 and 4. As a consequence, modules 102, 104, and 106 are retained centrally within the pipeline 110 since the arches 136 all resume their nominal shapes. This characteristic function of the centralizers 108 also apply to each of the various embodiments of the centralizers disclosed in the present application.

Further, it is possible to design the centralizers to achieve a desired level of “restoring force.” For example, it is possible to design the centralizers, including by the specific dimensions used for the arches 136 to create a restoring force from, for example, five to 20 pounds. In this regard, the material from which the centralizers are constructed may be specifically selected as well as the thicknesses of the arches 136, the widths of the arches 136, the number of arches 136 used per centralizer, the shape of the arc defined by the arches 136, as well as other design criteria, such as the stiffness or durometer of the material of the arches.

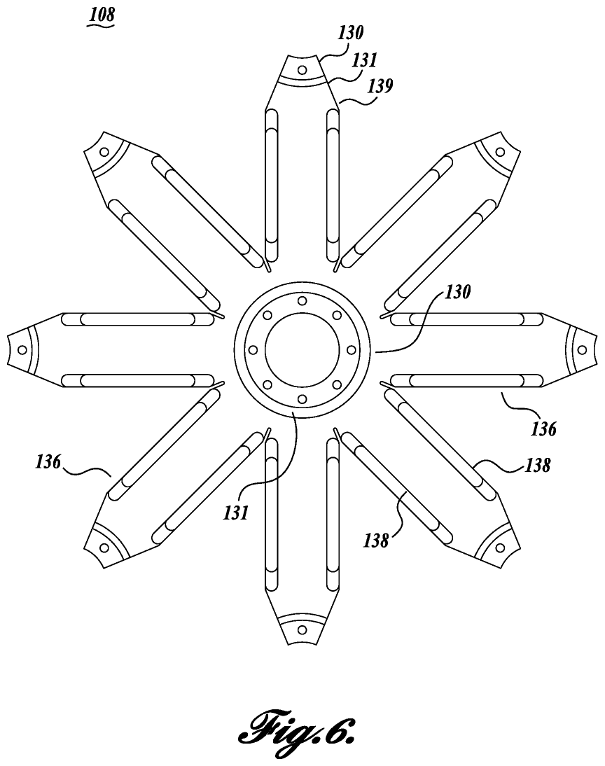

FIG. 6 illustrates one manner in which the centralizer 108 may be manufactured. As shown in FIG. 6, the centralizer 108 is in “flat” configuration, for example, as a molded shape. The arms that are used to form the arches 136 radiate out from flange structure 130. The centralizer is formed by flexing each of the radiating arms into an arch, whereupon the distal end portions 134 of the arms cooperatively define the opposing flange structure 130. Of course, other techniques or manners of manufacturing the centralizer 108 are possible.

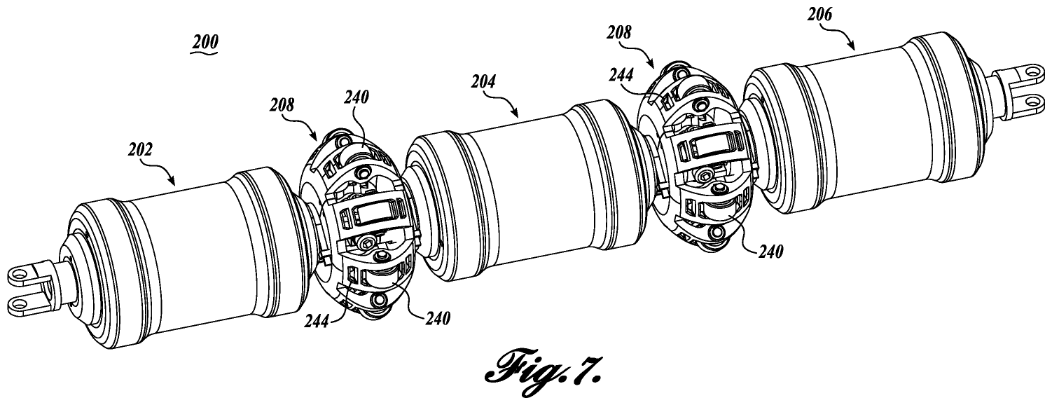

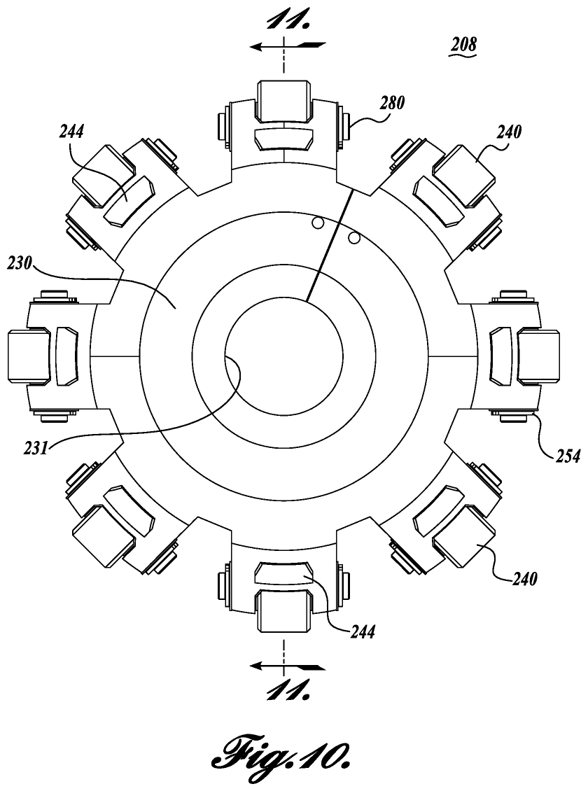

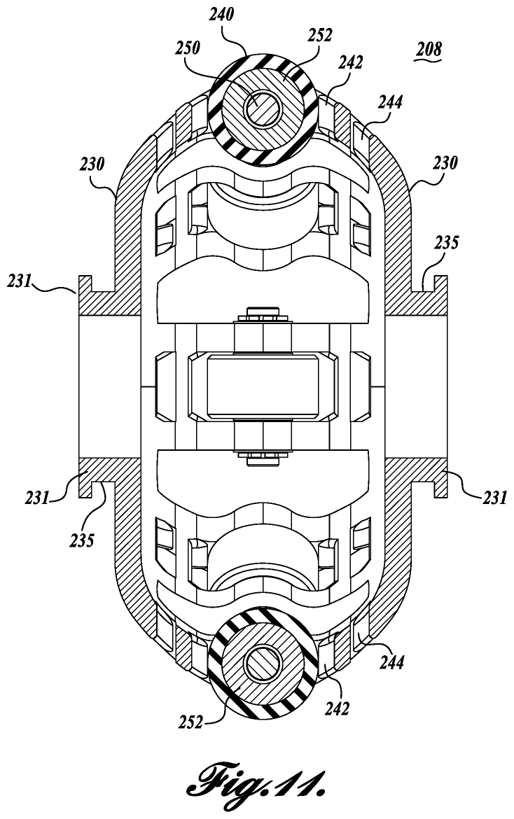

Next, referring to FIGS. 7-12, a portion of an ILI tool 200 is illustrated. Those components of tool 200 that are the same or comparable to the components of tool 100 are identified by the same part number but in the 200 series. Briefly, in this regard, ILI tool 200 includes first, second, and third modules 202, 204, and 206 separated by centralizers 208, which function to support and center the modules within a pipeline. As noted above with respect to modules 102, 104, and 106, the modules 202, 204, and 206 may house various tool components including sensors, signal generators, data processors, data loggers, power supplies, transceivers, etc. Because the modules can be of significant weight, the centralizers must be capable of supporting the modules close to, but away from the interior of the pipeline liner.

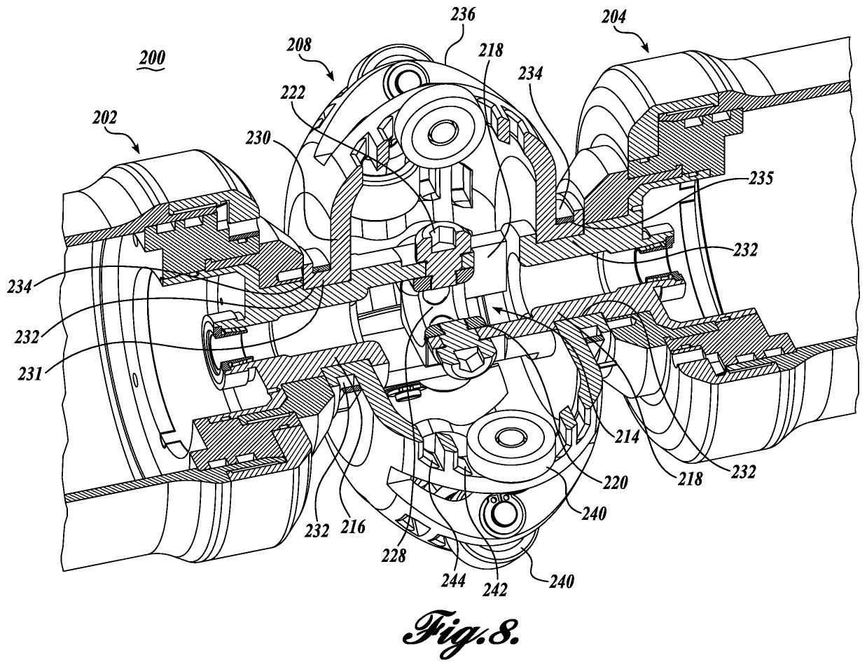

As shown in FIG. 8, the modules 202, 204, and 206 are interconnected by universal joints 214 positioned centrally within the centralizers 208. The universal joints 214 consist of yokes 216 and 218 projecting from the modules 202 and 204 to interconnect with a generally cube-shaped cross 220, which is sized to be received between the arms of the yokes. Bearing pins 222 extend through aligned holes formed in the yokes to engage within corresponding threaded cross-holes formed in the cross 220, thereby to attach the yokes to the cross while allowing relative rotation between the yokes and the cross. Also, as in cross 120, cross 220 is formed within hollow center 228 to enable cables, wires, etc., to pass therethrough between the adjacent modules.

Next, with respect to the construction of the centralizer 208, the centralizer includes flange structures 230 at each side of the centralizer. The flanges 230 define hubs 231 that have an internal shape and size to be snugly receivable within grooves 232 formed in the yokes 216 and 218 at locations inward of the yoke arms and exterior to the modules 202 and 204, see in particular FIG. 8. In this manner, the centralizers 208 are held captive between the adjacent modules. Moreover, the exterior of the hubs are shaped to define a groove 235 for receiving therein a retaining ring 234 thereby to help clamp the corresponding hubs 232 of the flange structures 230 into the yoke grooves 232.

The centralizer 208 includes arches/loops 236 that are configured to receive and support rollers 240 at the top or crown of the ridges so that the outer perimeter of the rollers 240 define the outwardly most perimeter of the centralizer 208. To this end, each loop 236 is constructed with central opening 242 that is sized and shaped to closely receive roller 240 therein. At a location between openings 242 and the corresponding flange structure 230, additional through holes 244 may be formed in the loops 236 to increase the flexibility of the loops, thereby enabling the loops to more readily flex under compression or tensile load, especially when the ILI 200 is rounding a corner.

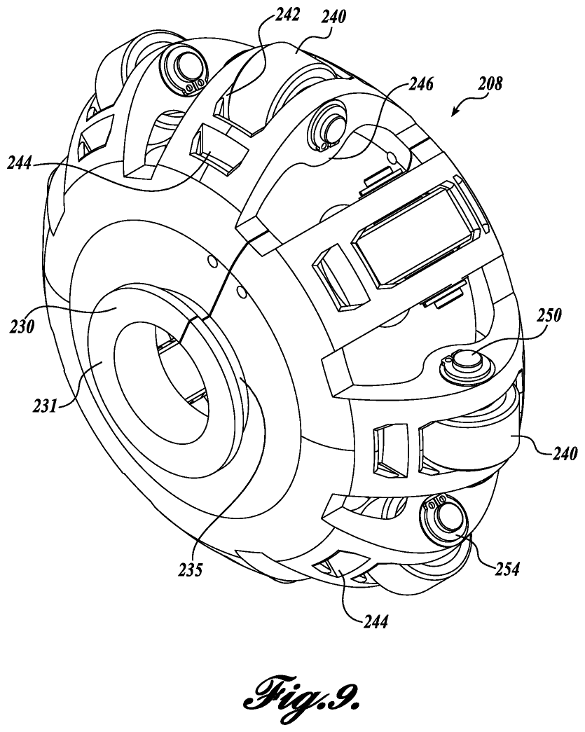

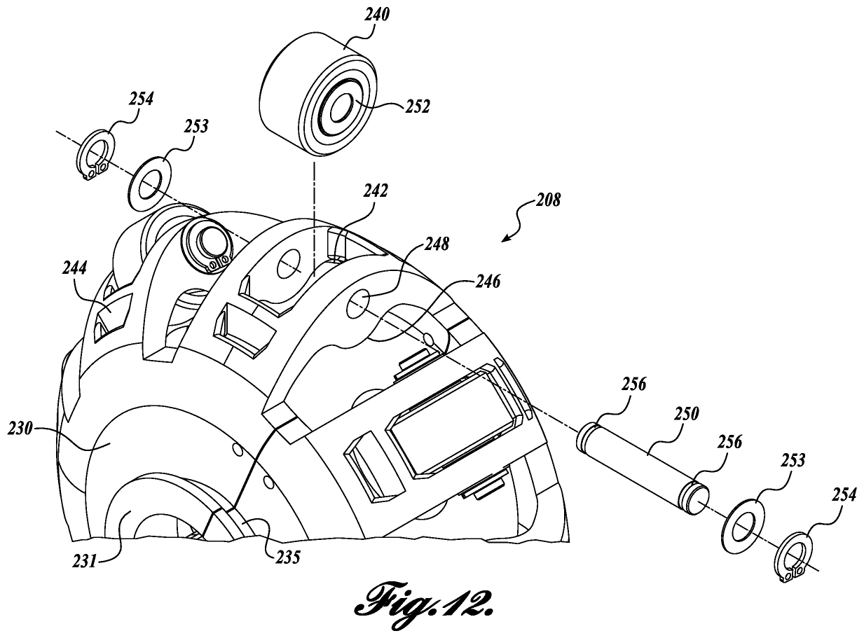

As perhaps most clearly shown in FIGS. 9 and 12, the thickness of the loops 236 increase at the crown of the loops to form a lobe 246, thereby providing sufficient material support for a through hole 248 for receiving and retaining therein an axle 250 used to support the roller 240. The axle extends through roller bearings or other type of bearings 252, which is pressed within the ID of the roller 240 to enable the roller to rotate freely on the axle 250. The axle 250 is retained within the through holes 248 by exterior flat washers 252 and then outwardly thereof by snap rings 254, which fit within grooves 256 formed at each end of the axle 250. As will be appreciated, the foregoing provides an uncomplicated, straightforward but very rugged and reliable mounting system for the rollers 240. As a consequence, rollers 240 are capable of rolling along the interior of a pipeline, including around pipeline bends and corners without damage to the pipeline interior liner.

Although eight separate loops 236, each with a roller 240, are illustrated as used in conjunction with centralizers 208, a fewer number or larger number of loops may be utilized with the centralizer, depending in part on the size of the pipeline within which the ILI 200 operates as well as the loads expected to be carried by the centralizers 208. In this regard, rather than utilizing a single centralizer 208 between each ILI module 202, 204, and 206, two centralizers 208 can be positioned next to each other to enable the centralizers to support larger loads than with the use of a single centralizer between each module.

The rollers 240 can be composed of various different materials. One apt material is polyurethane. Polyurethane rollers can be manufactured in various durometers (hardness or stiffness) as desired. Ideally, the rollers will be sufficiently stiff to be able to sufficiently carry the weight required of the centralizers with good durability, but not so stiff so as to damage the pipeline interior liner during travel of the ILI 200.

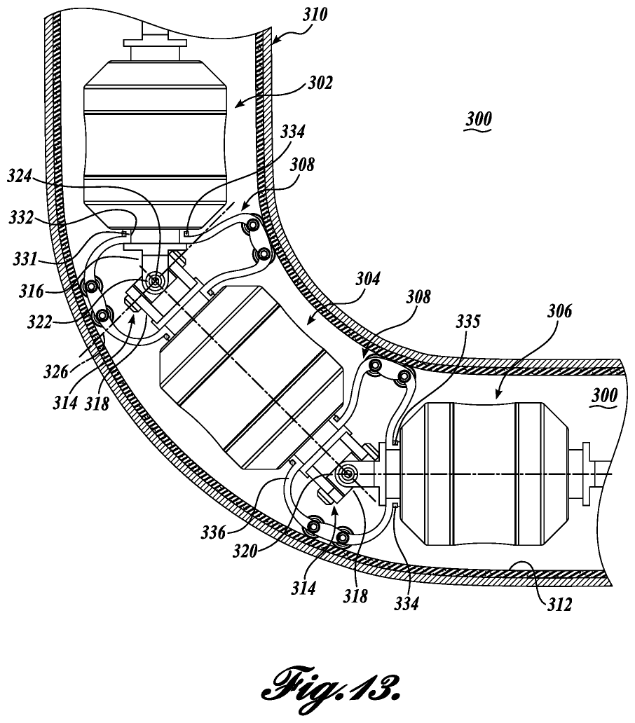

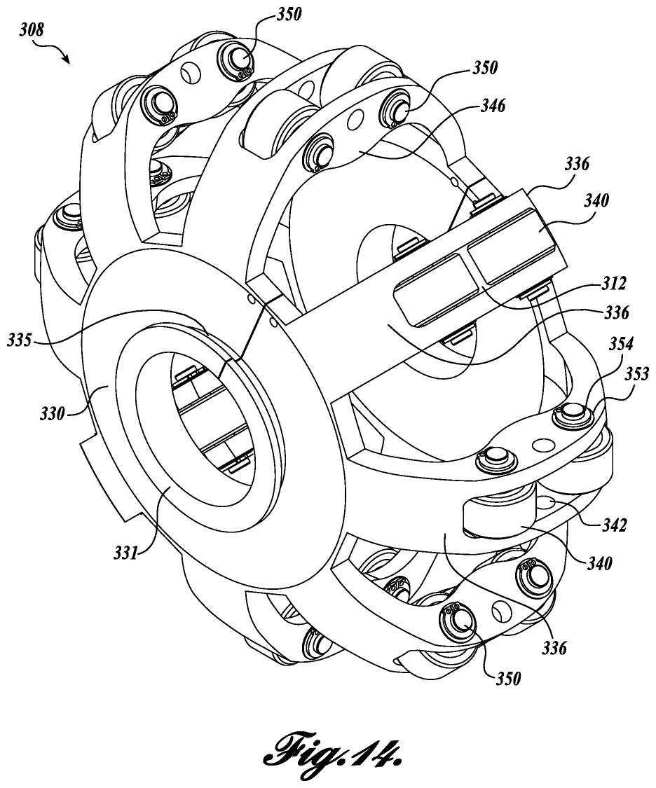

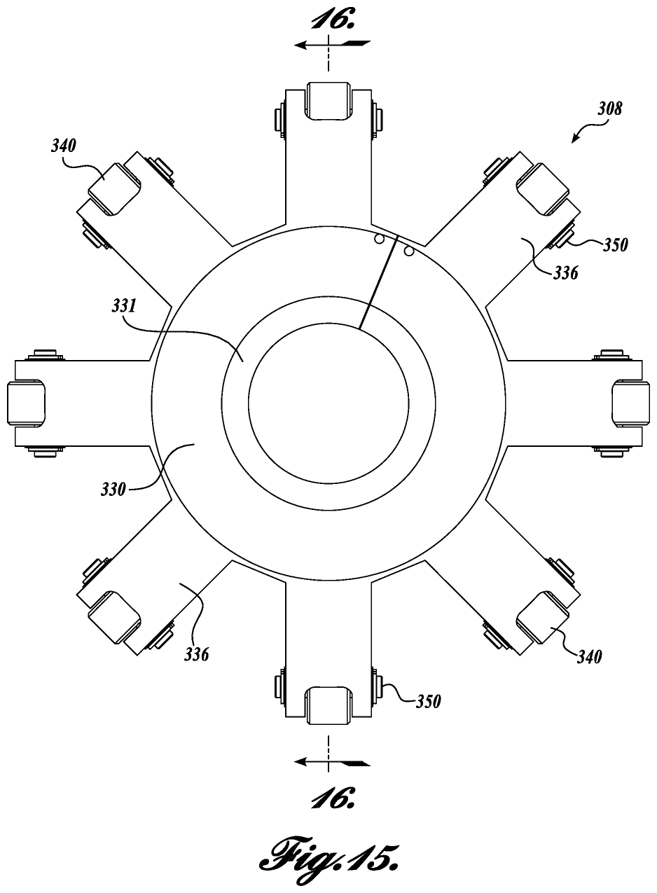

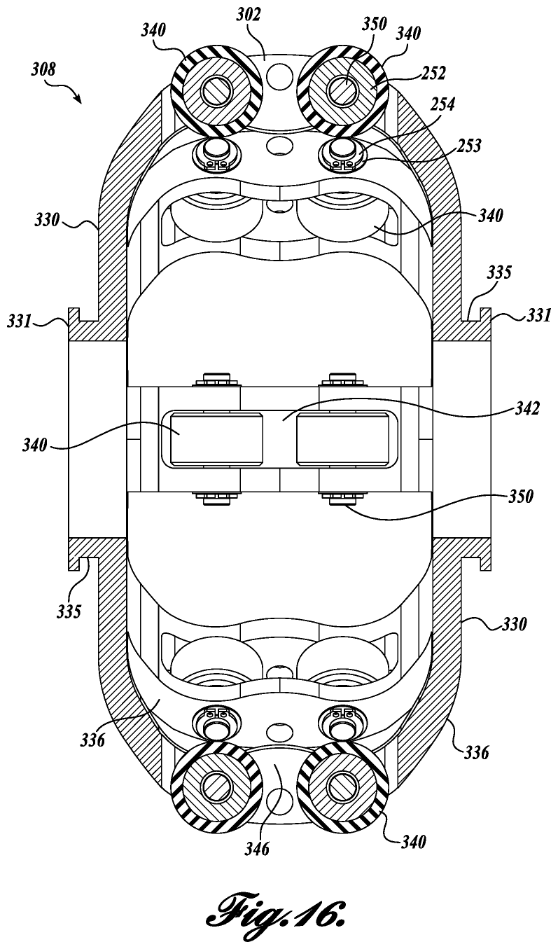

FIGS. 13-16 illustrate a portion of a further ILI tool 300, which includes first, second, and third modules 302, 304, and 306. These modules are separated by centralizers 308, which function to support and center the ILI tool 300 within a pipeline 310 that is lined with an internal liner 312. As with respect to the ILI tools 100 and 200 discussed above, the modules 302, 304, and 306 may house various tool components, including electromagnetic, acoustical or other type of signal generators, electromagnetic, acoustical, thermal, or visual or other types of sensors, as well as data processing equipment, power supplies, transceivers, etc. The centralizers 308 need to be sufficiently stiff to support the modules 302, 304, and 306 centrally within the pipeline 310, but without causing damage to the liner 312 during movement of the centralizers through the pipeline.

Also, with respect to tools 100 and 200 discussed above, the modules 302, 304, and 306 are interconnected by universal joints 314, each composed of yokes 316 and 318 projecting from modules 302 and 304, see FIG. 13. A cross 320, formed in a generally cubic shape, is sized to be received between the arms of the yokes 316 and 318. Bearing pins 322 extend through aligned holes formed in the yokes 316 and 318 to engage with corresponding cross holes formed in the crosses 320 to attach the yokes to the cross while allowing relative rotation between the yokes and the cross in a standard manner. As in crosses 120 and 220 noted above, the longitudinal center of cross 320 is also hollow to enable cables, wires, etc., to pass therethrough between modules 302 and 304.

Next, with respect to the construction of the centralizers 308, each centralizer includes flange structures 330 that form the opposing faces of the centralizer. Each of the flange structures 330 is shaped to define a hub portion 331 that is shaped to be receivable within grooves 332 formed in the yokes 316 and 318 inward of the yoke arms and exterior to the modules 302 and 304, see in particular FIG. 13.

As with respect to the centralizers 108 and 208 described above, a retainer 334 can engage within grooves 335 formed in the hub section 331 of the flanges 330 thereby to clamp the hub section within the yoke groove 332.

With respect to the construction of the centralizer 308, eight arches or loops 336 extend between the outer perimeters of the flanges 330 to cooperatively define a convex outward shape. As with loops 236, the loops 336 are configured to receive rollers 340. Rather than a single roller 240 as utilized in centralizer 208, the centralizer 308 utilizes pairs of rollers 340. The use of two rollers 340 per loop 336 helps to distribute the pressure imposed by the rollers on the pipeline liner 312 over a larger contact area.

To accommodate the dual rollers 340, an opening 342 is formed in the outermost portion of the loops 336. The rollers 340 are axled within the openings 342 to be supported by lobe-shaped sidewall portions 346 of the loops 336 in a manner similar to how the rollers 240 are mounted to loops 236 described above. The rollers 340 may be mounted to the loops 336 in the same manner as the rollers 240 are mounted to the loops 236, using axles 350 that engage through aligned openings formed in the loop sidewall positions 346 to extend through the center of bearings 352 in the manner described above.

FIG. 13 illustrates the centralizers 308 in use when negotiating a corner with tool 300. As shown in FIG. 13, when rounding a corner the loops 336 on the inside of the corner are compressed since the corresponding portions of the centralizer flanges 330 are closer together than normal on the diametrically opposite side of the centralizer where the perimeter of the flanges are spread apart then normal thereby placing the loops in tension. Nonetheless, the centralizers are able to sufficiently flex to support the modules 302, 304, and 306 centrally with respect to the inside diameter of the pipeline 310. Moreover, the use of two rollers 340 per loop 336 helps distribute the force imposed on the liner 312 by the rollers over a larger rolling contact area. Accordingly, less pressure is imposed on the liner 312 by the centralizer 308 than if a single roller, such as roller 340, were used.

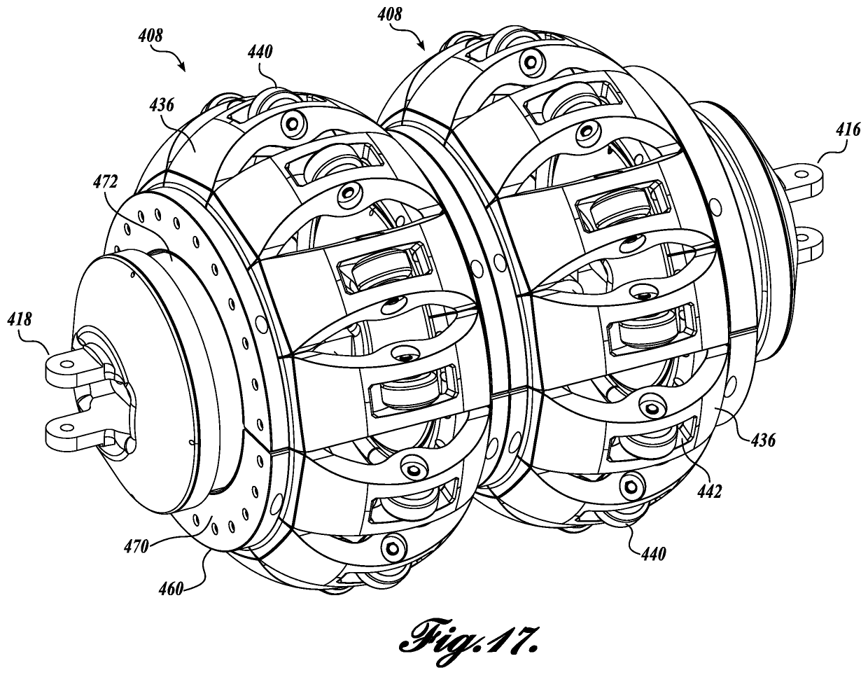

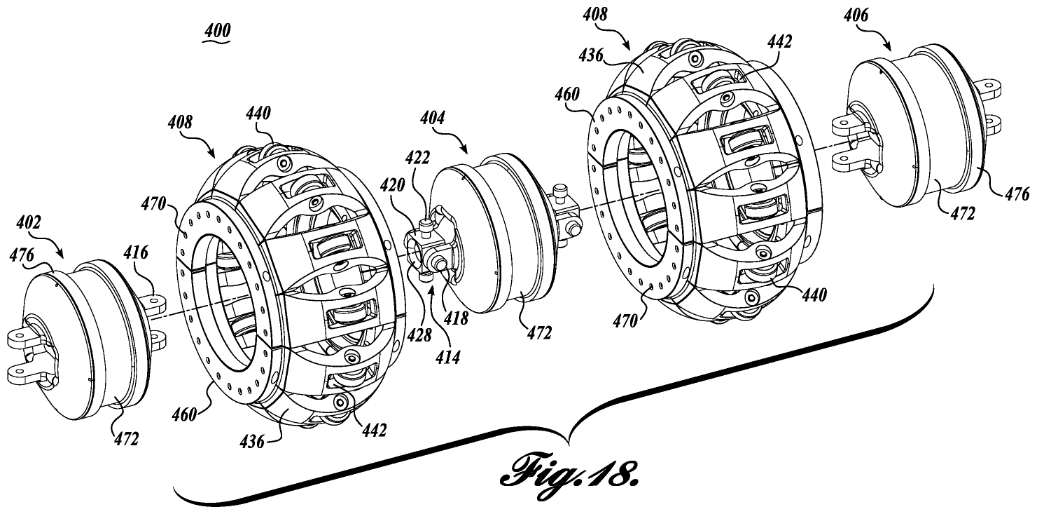

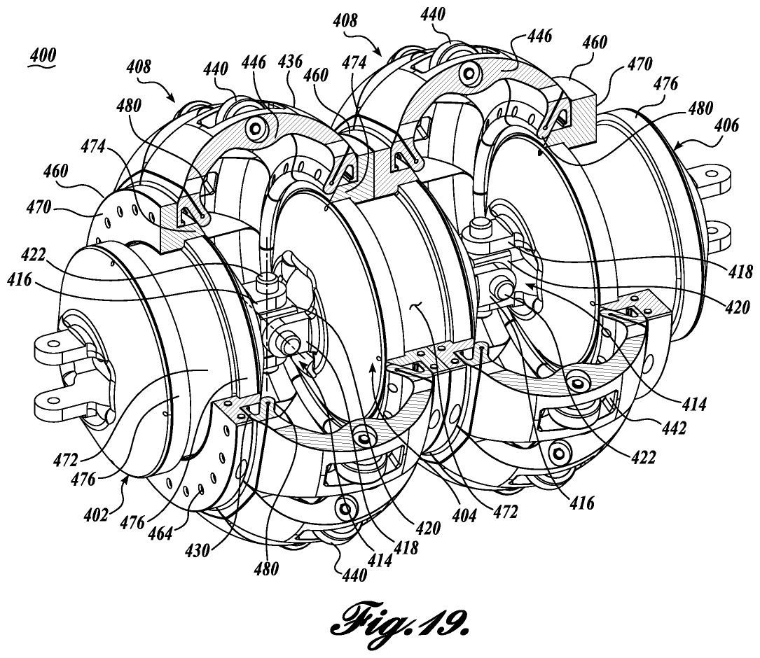

Next, referring to FIGS. 17-21, centralizers 408 are illustrated as being arranged in tandem, meaning two centralizers 408 are attached together and cooperate with modules 402, 404, and 406, see in particular FIGS. 18 and 19. The modules can house electronic components or batteries or other components. Modules 402, 404, and 406 can perform the same functions as discussed above with respect to the modules of ILI tools 100, 200, and 300. Because the two centralizers 408 are used in tandem, the positions of the modules 402, 404, and 406 relative to the centralizers 408 are somewhat different than in tools 100, 200, and 300.

With respect to tool 400, the center module 402 is positioned centrally with respect to the face to face intersection of centralizers 408, as shown in FIG. 19. Moreover, modules 402, 404, and 406 are each associated with flange structures 460 positioned at the opposite outward ends of the centralizers 408. The modules do include yokes 416 and 418 that are rotatably pinned to a cross 420 by bearing pins 422. As in centralizers 108, 208, and 308, in centralizers 408 the universal joints 414 are centrally aligned with the longitudinal center of the centralizers 408.

One difference between centralizers 408 and the prior described centralizers 108, 208, and 308 is that in centralizers 408, separate flange rings 460 are utilized to interconnect the modules 402, 404, and 406 with the centralizers 408. Such flange structures are structurally separate from the loops 436 of the centralizers 408. Such flange rings 460 include an annular flange face 470 having an interior diameter that seats within an exterior groove 472 formed within the modules 402, 404, and 406 by module rims and edges 476. The flange rings 460 also include a web section 474 that extends longitudinally (relative to the direction of travel of the tool 400) over the external diameter of the adjacent module edge 476. The module groove 472 is wide enough to receive snugly therein two flange rings 460, as shown in FIG. 19. Such two flange rings can be bolted together in place.

With respect to the construction of the centralizers 408, each includes a flange portion 430 on each side of the centralizer for bearing against the adjacent surface of flange 460.

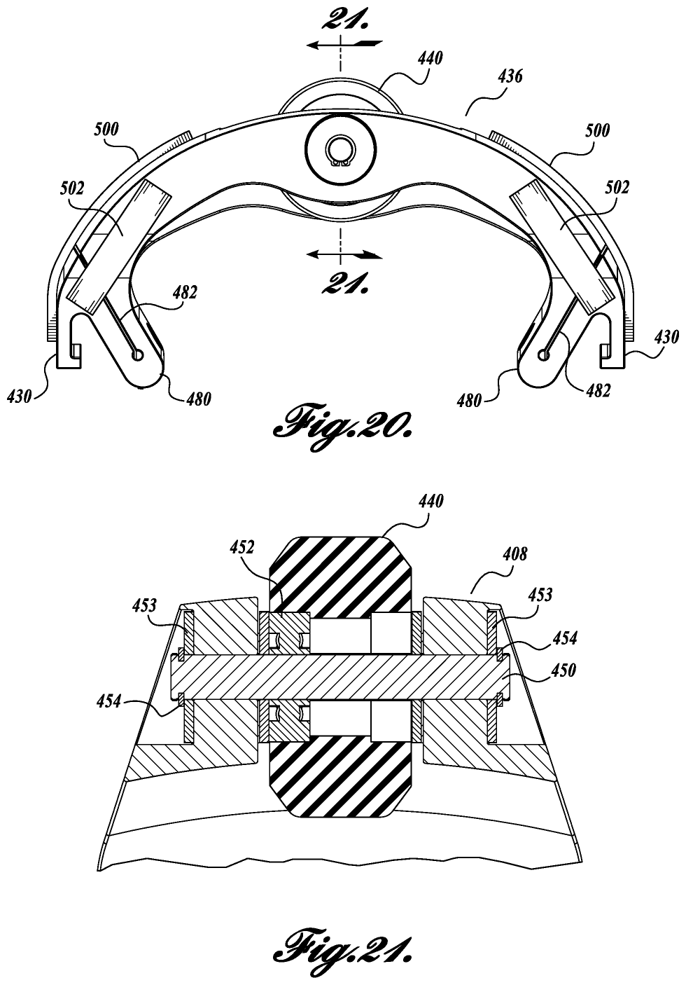

Each loop 436 of centralizer 408 also includes a lug portion 480 that forms an extension of the loop 436 at the ends thereof. The lug 480 is positioned to nominally bear against the adjacent sloped surface of web section 474 of the flange structure 460. The purpose of the lug 480 is to add structural integrity to the loop 436. So as to maintain the flexibility of the loop 436, a slot 482 extends centrally through the lug 480 to extend to the exterior surface of the loop, see in particular FIGS. 19 and 20. This slit 482 provides added flexibility to the loops 436, and especially the end portions thereof.

Each loop 436, as shown particularly in FIG. 21, is configured to receive centrally therein a roller 440, mounted to the loop 436 in much the same manner as roller 240 is mounted to loop 236, described above. Accordingly, that description will not be repeated here.

In operation, when the ILI tool 400 negotiates a corner or turn in a pipeline, the two centralizers are able to flex individually as well as cooperatively. The individual flexing of the centralizers is made possible because of the universal joints 414 located centrally with respect to each of the centralizers. This enables flexure of the loops 436 of each centralizer 408 in a manner similar to that already described above with respect to centralizers 108, 208, and 308. Because the centralizers 408 are joined together, the flexure of the loops 436 of one centralizer when rounding a corner will have an effect on the adjacent centralizer, which is constructed to be able to accommodate the flexure in the loops of the adjacent centralizer.

The centralizer 408 can be constructed from the unitary structure wherein all of the loops 436 are joined together at the ends of the loops. Alternatively, the centralizer can be constructed wherein each of the loops 436 is a separate structure. In either situation, the flange structures 430 of the loops 436 can be physically attached to the flange rings 460 by mechanical fasteners or other means. In this regard, fasteners can extend through or be engaged with openings 464 located around the circumference of the annular flange rings 460.

FIG. 20 illustrates the optional use of stabilizing strips 500 and 502 with respect to centralizer 400. However, this feature can also be used with the centralizers 200 and 300 described above. As shown in FIG. 20, exterior stabilizing strips 500 are attached to the outer convex surface of the loops 436. The ends of the stabilizers are physically attached to the loops 136 by any appropriate means, including, for example, by adhesive or mechanical fastener. Side stabilizers 502 can be applied to the side edges of the loops 436, for example, at locations overlapping lugs 480, as shown in FIG. 20. The stabilizers 500 and 502 are constructed from a durable, flexible material, for example, polyurethane. This enables the stabilizers to flex with the flexure of the loops 436 but then the stabilizers impose a restoring force to the loops 436 to assist or help the loops return to their nominal shape after compression or extension which occurs when rounding a corner or bend in a pipeline. FIGS. 5 and 13 illustrate that it is necessary for the loops of the centralizers to undergo significant flexure when supporting an ILI tool when negotiating a corner or bend of a pipeline.

While illustrative embodiments have been illustrated and described, it will be appreciated that various changes can be made therein without departing from the spirit and scope of the invention.

1. A centralizer for centrally locating measuring/testing equipment within the interior of a pipeline while traveling through the pipeline, comprising:
(a) a first flange structure;
(b) a second flange structure nominally spaced from the first flange structure along the direction of travel of the centralizer;
(c) a plurality of radially outwardly curved loops extending between the first and second flange structures, said curved loops defining an outwardly convex outer surface; and
(d) one or more ridges extending along the loops to project outwardly of the outer surfaces of the loops to extend above the remainder of the outer surface of the loops.

2. The centralizer according to claim 1:
wherein the loops have side edge portions; and
wherein ridges extend along the side edge portions of the loops.

3. The centralizer according to claim 1, wherein the loops, when in an undeformed state, comprise flat straps that extend radially and substantially coplanar to each other from a first flange structure to terminate at distal end portions.

4. The centralizer according to claim 3, wherein the outwardly concave form of the loops is created by flexing each of the nominally linear straps over on itself so that the distal end portions of the straps meet together at a location spaced apart from the first flange structure in a direction along the direction of travel of the centralizer.

5. The centralizer according to claim 4, wherein the radial end portions of the straps are configured to define at least a portion of the second flange structure when the nominally straight straps are flexed over on themselves to form loops.

6. The centralizer according to claim 4, wherein the loops provide a resistance load against the movement of the first and second flange structures toward each other.

7. The centralizer according to claim 6, wherein the resistance load against the first and second flanges of a centralizer moving relatively toward each other is in the range of about 3 to 20 pounds' force.

8. A centralizer assembly comprised of two or more centralizers constructed in accordance with claim 1, wherein the one flange structure of a first centralizer is disposed face-to-face with the adjacent flange of the second centralizer.

9. An apparatus for measuring/testing the condition of a pipeline wherein an articulating joint is disposed within the centralizer of claim 1 between the first and second flange structures of the centralizer of claim 1.

10. The apparatus of claim 9, wherein the articulating joint interconnects adjacent components of measuring/testing equipment.

11. A centralizer for centrally locating measuring/testing equipment within the interior of a pipeline while traveling through the pipeline, comprising:
(a) a first annular face structure;
(b) a second annular face structure nominally spaced from the first face structure along the direction of movement of the centralizer, the first and second face structures nominally aligned with each other along a first axis coinciding with the direction of travel of the centralizer through the pipeline;
(c) a plurality of radially outwardly curved loops extending between the first and second face structures;
(d) one or more wheels mounted on the loops to define the maximum outer perimeter of the centralizer, said one or more wheels mounted on a rotational axis extending nominally transversely to the first axis, the one or more wheels adapted to roll against the interior of the pipeline structure being inspected/tested.

12. The centralizer according to claim 11, wherein the loops are formed with openings for closely receiving the wheels therein.

13. The centralizer according to claim 12, wherein the loops define a thickness, with the thickness of the loops at the location that the wheels are mounted on the loops being increased in thickness to define mounting bosses for axles on which the wheels are journaled.

14. The centralizer according to claim 10, wherein the loops are formed with distal end lugs adjacent the juncture of the loops with the first and second face structures.

15. The centralizer according to claim 14:
wherein the loops define a convex outer surface; and
further comprising one or more flexible reinforcing strips extending along the outer surfaces of the loops, the reinforcing strips loading the loop to bias the loop to maintain its nominally curved shape.

16. The centralizer according to claim 15:
wherein the loops defining side surfaces generally transverse to the outer surface of the loops; and
further comprising one or more nominally straight reinforcing strips overlapping the side surfaces of the loops.

17. The centralizer according to claim 11:
wherein the loops define a convex outer surface; and
further comprising one or more flexible reinforcing strips extending along the outer surface of the loops, the reinforcing strips mounted to the loops to bias the loops to their nominally curved shape.

18. The centralizer according to claim 11:
wherein the loops have side surfaces; and
further comprising reinforcing strips overlapping the side surfaces of the loops, said side surfaces applying a load to the loops to bias the loops to maintain their nominally curved shape.

19. The centralizer according to claim 11, further comprising two wheels mounted on the loops, the outer circumference of the two wheels defining the outer perimeter of the centralizer, the two wheels mounted on the loops about rotational axles extending generally transversely to the first axis.

20. The centralizer according to claim 11, further comprising an articulating joint disposed within the interior of the centralizer and spanning between the first and second face structures.
